(19) United States
(12) Patent Application Publication
(10) Pub. No.: US 2018/0063930 A1
(43) Pub. Date: Mar. 1, 2018

(54) Universal Dimming Apparatus

(71) Applicant: Jasco Products Company LLC, Oklahoma, OK (US)

(72) Inventors: Cameron Trice, Oklahoma City, OK (US); Mark Wade Simpkins, Stillwater, OK (US)

(21) Appl. No.: 15/691,151

(22) Filed: Aug. 30, 2017

Related U.S. Application Data
(60) Provisional application No. 62/381,348, filed on Aug. 30, 2016.

(51) Int. Cl. H05B 37/02

(52) U.S. Cl. CPC H05B 37/0281; H05B 37/0272; H05B 37/0227

(57) ABSTRACT

A universal dimming apparatus with an integrated timer to adjust brightness levels according to a preset schedule consists of a power source, a microcontroller, a dimmer user interface, an integrated timer, an internal storage device, and a phase-cut dimmer unit. The power source provides the necessary electric power. The dimmer user interface allows the user to enter a preferred schedule for a lighting system with a preferred brightness level. The user entered data is stored in the internal storage device. The integrated timer and the phase-cut dimmer unit draws the stored information via the microcontroller. An indicator light is used to notify the user regarding the reduced brightness levels.

The current application claims a priority to the U.S. Provisional Patent application Ser. No. 62/381,348 filed on Aug. 30, 2016.

### FIELD OF THE INVENTION

The present invention relates generally to lighting systems. More specifically, the present invention introduces an apparatus that can be used for switching between brightness levels at predetermined times by integrating brightness changes with user selectable time intervals. Moreover, the present invention allows for prompt switching between full brightness and a predetermined reduced brightness level.

### BACKGROUND OF THE INVENTION

Dimmers generally consist of rotary dials or sliding levers that need to be adjusted manually and provide no method of controlling dimmer levels as a function of time. If a homeowner wishes to set different brightness levels at different times of the day, dimming the lights to the preferred level needs to be done manually. Else, the lights need to be dimmed with an interconnected clock operated switch and a separate dimmer. Consistency and accuracy of such approaches are considerably low. Thus, the need for a consistent time selectable dimming system is clearly evident.

The lack of timed dimming levels in a lighting system can result in unwanted power consumption and undesirable brightness levels. As an example, the brightness level of a lighting system can be too bright during the day. By introducing a specific brightness level for a specific time period, the power consumption during the day can be minimized while allowing an automatic increased brightness for evening and night times.

Homeowners generally leave the lighting system switched on for security purposes when leaving the property. Even though the intended purpose is fulfilled, the waste of energy is significant. Thus, the need for a method that can switch on a lighting system at a predetermined time, at a lower energy consumption level and a beneficial brightness level is clearly evident.

The objective of the present invention is to address the aforementioned issues. In particular, the present invention introduces an apparatus that allows the user to adjust lighting to a desired level at a specific time and then automatically switch to another preset brightness level at a specified time. The apparatus also allows for conveniently switching back to full brightness with a single user activated control. Moreover, the present invention allows the user to dim or brighten the light or plurality of lights consistently at a user programmed time. Thus, allowing for accurate automatic setting of brightness at user selected times.

### BRIEF DESCRIPTION OF THE DRAWINGS

FIG. 1 is a block diagram illustrating the present invention.

FIG. 2 is another block diagram illustrating the present invention.

FIG. 3 is an illustration of the present invention, wherein a rocker switch is used.

FIG. 4 is an illustration of the present invention, wherein the keypad and the display screen are shown.

### DETAIL DESCRIPTIONS OF THE INVENTION

All illustrations of the drawings are for the purpose of describing selected versions of the present invention and are not intended to limit the scope of the present invention.

The present invention introduces an apparatus that is used for dimming a single light or a plurality of lights of an existing lighting system. By utilizing the present invention, the user can promptly switch between a desired brightness and full brightness as preferred. More specifically, the user can set a preferred brightness level for a selected time interval.

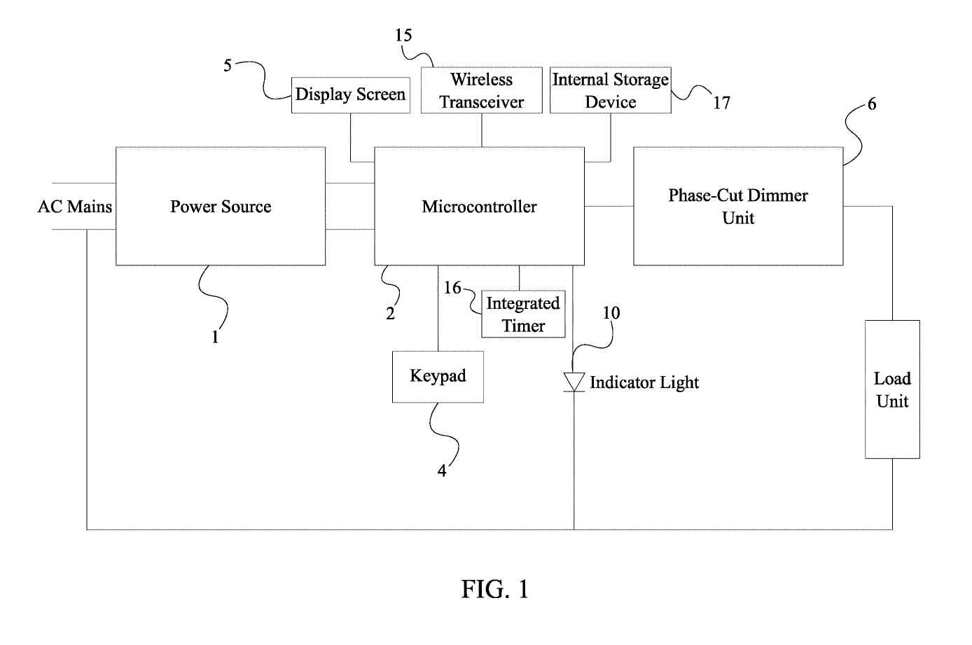

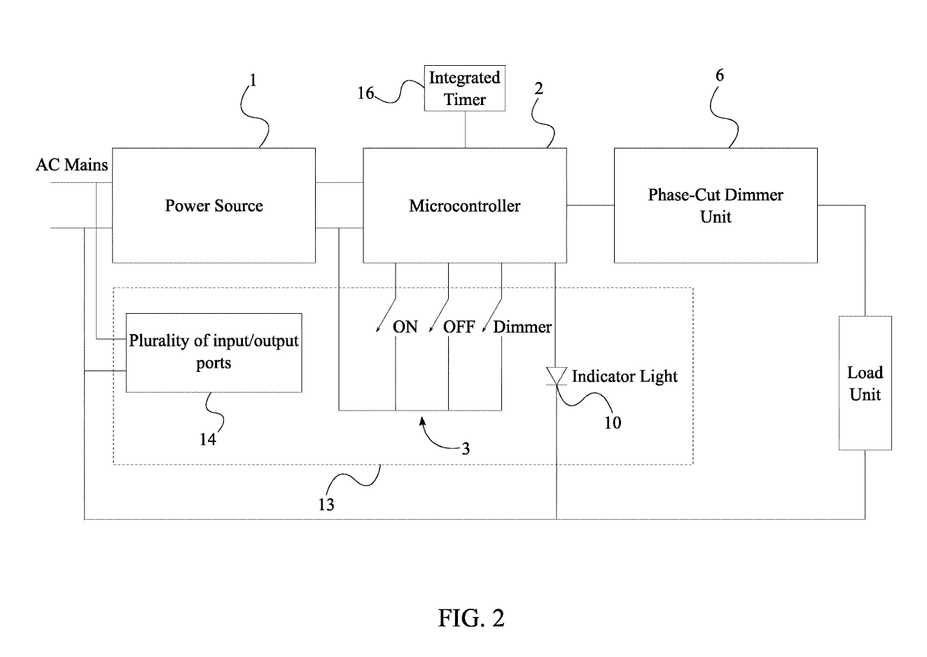

As illustrated in FIG. 1 and FIG. 2, to adjust brightness according to user preference, the present invention comprises a power source 1, a microcontroller 2, a dimmer user interface 3, a phase-cut dimmer unit 6, an integrated timer 16, and an internal storage device 17. The present invention functions with the electrical power supplied by the power source 1 which can vary in different embodiments of the present invention. For instance, for a considerably large lighting system, a large power source is required. On the other hand, for a considerably small lighting system, a comparatively smaller power source is required. The microcontroller 2 is used to execute the circuit functionalities of the present invention. More specifically, the microcontroller 2 is used to implement changes to a lighting system as determined by the user. Preferred brightness levels and the schedule for the preferred brightness levels are entered via the dimmer user interface 3. In other words, the dimmer user interface 3 allows the user to input instructions to the present invention so that the brightness level of the connected lighting system changes accordingly. When entered, information regarding different brightness levels and information regarding the time intervals for the preferred brightness levels are stored in the internal storage device 17. The phase-cut dimmer unit 6 reduces the average voltage that is applied across a lighting system according to the user input. More specifically, the brightness of the lighting system, which can be a single light or a plurality of lights, is adjusted according to the user input stored in the internal storage device 17. In addition to the phase-cut dimmer unit 6, the integrated timer 16 is used in the process of adjusting the brightness level of the lighting system according to the user set time intervals.

To execute the electronic functionalities of the present invention, the power source 1 is electrically connected to the microcontroller 2, the dimmer user interface 3, the integrated timer 16, the internal storage device 17, and the phase-cut dimmer unit 6. To store information regarding the brightness levels preferred by the user, the dimmer user interface 3 is electronically connected to the internal storage device 17. To control the brightness of the lighting system the present invention is being used on, the internal storage device 17 is electronically connected to the phase-cut dimmer unit 6 and the integrated timer 16 via the microcontroller 2. Thus, the microcontroller 2 can transfer the user preferences from the internal storage device 17 to the connected lighting system so that the preferred brightness level is obtained at preferred times.

The present invention further comprises an indicator light 10 that is used to notify the user when the present invention is active. To provide accurate information regarding the status of the present invention, the indicator light 10 is electronically connected to the dimmer user interface 3. Thus, whenever the user activates the present invention, the user is simultaneously notified via the indicator light 10. Moreover, when the indicator light 10 is off, the user is notified that the present invention is deactivated. Preferably, the indicator light 10 is a light-emitting diode (LED). However, a light-dependent resistor (LDR) or other comparable methods can be used instead of the indicator light 10 in other embodiments of the present invention.

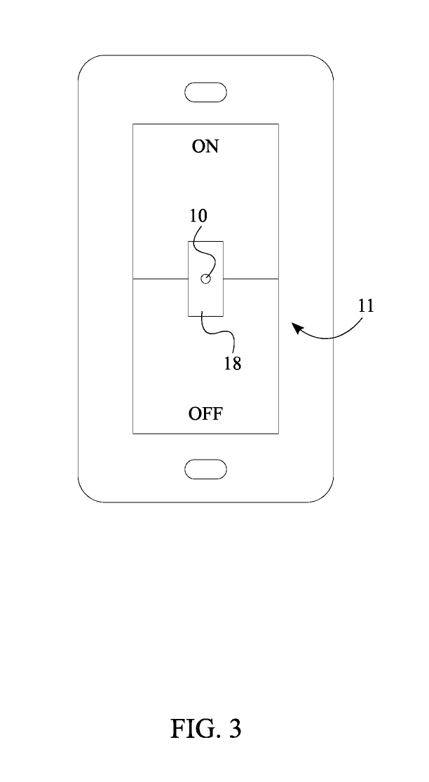

The dimmer user interface 3 can vary in different embodiments of the present invention. As illustrated in FIG. 3, in one embodiment of the present invention, the dimmer user interface 3 comprises a rocker switch 11. In such instances, the indicator light 10 and a momentary pushbutton 18 will be mounted onto the rocker switch 11. The momentary pushbutton 18 is used to select the preferred brightness level for the lighting system. To transfer the relevant information via the microcontroller 2, the momentary pushbutton 18 is electronically connected to the microcontroller 2.

When the rocker switch 11, the indicator light 10, and the momentary pushbutton 18 are used to control the brightness level of a lighting system, the following process flow is generally followed. Initially, the rocker switch 11 is turned on to provide power to the lighting system. Since the lighting system illuminates at full brightness, the indicator light 10 is not illuminated. To select a desired brightness level, the momentary pushbutton 18 is depressed and held until the desired brightness level is reached. When the momentary pushbutton 18 is held to set the desired brightness level, the indicator light 10 is simultaneously turned on to notify the user that the lighting system is at a reduced brightness. Thus, when the rocker switch 11 is switched off and then switched on, the lighting system illuminates at the reduced brightness level previously selected. If the indicator light 10 is switched off when the rocker switch 11 is turned on, the lighting system illuminates at full brightness.

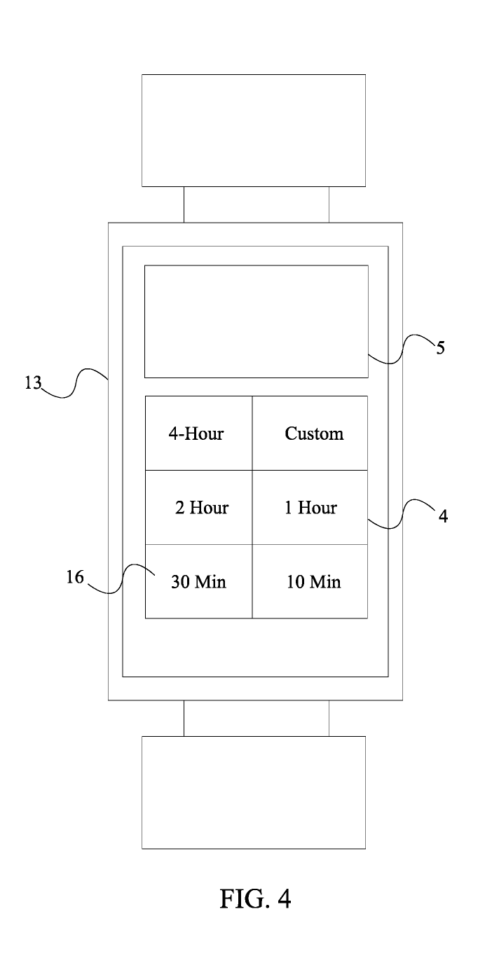

As illustrated in FIG. 4, in another embodiment of the present invention, the dimmer user interface 3 comprises a keypad 4 and a display screen 5. The keypad 4 and the display screen 5 are electrically connected to the power source 1 and electronically connected to the internal storage device 17. Thus, the user can provide a preferred input with the use of the keypad 4 and save the preferred input in the internal storage device 17. Moreover, the input can also be viewed on the display screen 5. In another embodiment of the present invention, the keypad 4 comprises a plurality of pushbuttons that is associated with a preset time. Since the keypad 4 is electronically connected to the internal storage device, the integrated timer 16 can draw information regarding the preset time and adjust the brightness of the lighting system accordingly.

The present invention can also be designed with an ornamental design to be used as a desktop lighting control unit. In such instances, the present invention further comprises a housing 13 and a plurality of input/output ports 14. When the housing 13 is available, the dimmer user interface 3 is positioned within the housing 13 to maintain an aesthetically pleasing appearance. The plurality of input/output ports 14 function as a charging port for mobile devices and other comparable devices. To do so, the plurality of input/output ports 14 traverse into the housing 13 and is electronically connected to the power source 1. Each of the plurality of input/output ports 14 can be, but is not limited to, a universal serial bus (USB) port.

As further illustrated in FIG. 1, to enhance user convenience, another embodiment of the present invention comprises a wireless transceiver 15 so that the user can remotely control the functionalities of the present invention. In such instances, the wireless transceiver 15 is electronically connected to the dimmer user interface 3 so that information stored on the internal storage device 17 can be accessed remotely.

When the present invention is in use, the following process flow is generally followed. Initially, the user utilizes the dimmer user interface 3 to determine the preferred brightness levels and the times for the preferred brightness levels. When available, the keypad 4 and the display screen 5 are used to enter the necessary information regarding the brightness levels and the times for the brightness levels. The data entered through the dimmer user interface 3 is saved on the internal storage device 17. Next, when the lighting system is switched on, the phase cut dimmer unit 6 accesses the internal storage device 17 to determine the brightness level for the lighting system. When the present invention is activated, the indicator light 10 is illuminated.

Although the invention has been explained in relation to its preferred embodiment, it is to be understood that many other possible modifications and variations can be made without departing from the spirit and scope of the invention as hereinafter claimed.

What is claimed is:

1. A universal dimming apparatus with an integrated timer for implementing control of lighting with at least one programmable setting of time and brightness level comprises:
a power source;
a microcontroller;
a dimmer user interface;
an integrated timer;
an internal storage device;
a phase-cut dimmer unit;
the power source being electrically connected to the microcontroller, the dimmer user interface, the integrated timer, the internal storage device, and the phase-cut dimmer unit;
the dimmer user interface being electronically connected to the internal storage device; and
the internal storage device being electronically connected to the phase-cut dimmer unit and the integrated timer via the microcontroller.

2. The universal dimming apparatus with an integrated timer for implementing control of lighting with at least one programmable setting of time and brightness level as claimed in claim 1 further comprises:
an indicator light; and
the indicator light being electronically connected to the dimmer user interface.

3. The universal dimming apparatus with an integrated timer for implementing control of lighting with at least one programmable setting of time and brightness level as claimed in claim 2, wherein the indicator light is a light-emitting diode (LED).

4. The universal dimming apparatus with an integrated timer for implementing control of lighting with at least one programmable setting of time and brightness level as claimed in claim 1 further comprises:
a momentary pushbutton;
the dimmer user interface comprises a rocker switch;
an indicator light being mounted onto the rocker switch;
the momentary pushbutton being mounted onto the rocker switch; and
the momentary pushbutton being electronically connected to the microcontroller.

5. The universal dimming apparatus with an integrated timer for implementing control of lighting with at least one programmable setting of time and brightness level as claimed in claim 1 further comprises:
dimmer user interface comprises a keypad and a display screen; and
the keypad and the display screen being electronically connected to the internal storage device.

6. The universal dimming apparatus with an integrated timer for implementing control of lighting with at least one programmable setting of time and brightness level as claimed in claim 1 further comprises:
a housing;
a plurality of input/output ports;
the dimmer user interface being mounted onto the housing;
the plurality of input/output ports being electronically connected to the power source; and
the plurality of input/output ports traversing into the housing.

7. The universal dimming apparatus with an integrated timer for implementing control of lighting with at least one programmable setting of time and brightness level as claimed in claim 1 further comprises:
a wireless transceiver; and
the wireless transceiver being electronically connected to the dimmer user interface.
